(19) United States
(12) Patent Application Publication
(10) Pub. No.: US 2013/0255505 A1
(43) Pub. Date: Oct. 3, 2013

(54) Venturi-Type Wine Aerator With Adjustable Aeration

(71) Applicant: James M. Verbicky, San Clemente, CA (US)

(72) Inventor: James M. Verbicky, San Clemente, CA (US)

(21) Appl. No.: 13/434,129

(22) Filed: Mar. 29, 2012

(51) Int. Cl. B01F 3/04

(52) U.S. Cl. 99/323.1

(57) ABSTRACT

A venturi-based wine aerator having a fluid passage that includes a throat portion for drawing air bubbles into the passing wine, the aerator including a plurality of differently sized air passages that lead to the throat portion of the fluid passage for producing air bubbles of a corresponding plurality of different sizes.

### BACKGROUND OF THE INVENTION

1. Field of the Invention

The present invention generally pertains to wine aerators and, more particularly, to Venturi-type wine aerators with adjustable aeration.

2. Description of the Prior Art

It is generally believed that wines, especially red wines, improve in taste after being exposed to the air for a period of time before being served. Sometimes this process occurs over time by simply letting the wine remain in the bottle for a bit after the wine has been opened, or after the wine has been poured into a receptacle such as a glass, or both. This is sometimes called letting the wine “breathe.” The process of allowing the wine to breathe can be accelerated by decanting the wine, i.e. by pouring the wine into a decanter that exposes more liquid surface area to the air.

A number of wine aerators have been developed to accelerate the aeration process while pouring the wine into a decanter. Perhaps the oldest wine aerators are the so-called wine funnels or wine strainers, often made of metal such as silver or pewter. A typical wine funnel consists of a funnel and a strainer formed from an apertured plate located near the top of the funnel. When the wine is poured into the wine funnel, it passes through the strainer and is divided into many fine streams, thereby exposing more of the wine's surface to the air and providing some aeration during the decanting process. However, the amount of aeration is relatively limited and usually cannot be varied for different types of wines.

The inventor is aware of a relatively recent wine funnel that that provides for adjustability, namely the Epicureanist “Trilux Wine Aerator.” According to related marketing materials, it allows the user to select from three different levels of aeration. However, it appears to simply involve an adjustable strainer. In particular, the Trilux Wine Aerator appears to function like a wine funnel with an internal strainer. The aeration occurs as the wine divides past a strainer and the amount of aeration is set by rotating two adjacent plates to vary the number and size of the apertures within the strainer. Since it operates by simply dividing the wine into a number of different streams, the level of aeration is still believed to be relatively limited.

Of recent, more effective “Venturi-type” wine aerators based on the Venturi effect have become popular. In Venturi-type wine aerators, wine passing through a constriction or narrowed part of a fluid path increases in velocity and lowers in pressure according to the Bernoulli principle, thereby drawing air into the passing wine from one or more air holes that are exposed to the constriction. Such devices essentially create a vacuum to pull air bubbles into a passing stream of wine. The following patents exemplify the Venturi-type wine aerators that use the Venturi-effect:

U.S. Pat. No. 6,568,660, issued to Torben Flanbaum on May 27, 2003, discloses a pourer 101 that fits into the opening of a wine bottle like a conventional pour spout, and provides an “air intake opening” 106 that opens into a “venture-like contraction” 105 for introducing air into the passing wine.

U.S. Pat. Nos. 7,614,614 and 7,841,584, issued to Sabadicci et al. on Nov. 10, 2009 and Nov. 30, 2010, respectively, are directed to a so-called “venturi apparatus” that receives wine poured from a bottle. In the disclosed apparatus, the wine is first received within an upper funnel section 14 and thereafter passes downward through a first cylindrical passage 16, an intermediate passageway 18 of greater cross-sectional area, a second cylindrical passageway 28, and ultimately into a receptacle such as a decanter or a wine glass. The apparent innovation was that the intermediate passageway's greater cross-sectional area improved on the Venturi effect.

The wine aeration devices disclosed in the above patents provide for effective Venturi-type aeration, but since they only feature one or two air holes or “sidearm passageways” 20, 24 of fixed size, the air bubbles that are introduced into the wine during aeration are also of generally fixed size. In the world of wine, one size does not fit all.

Many industry members believe that different types of wine will benefit from different levels of aeration for optimum release of flavors and aromas. For example, a lighter red wine like a pinot is best after a small amount of aeration and a heavier red wine like a cabernet sauvignon would benefit from increased aeration.

In the inventor's opinion, a wine aerator that uses the Venturi effect is much more effective than a wine strainer because a Venturi-type wine aerator actually introduces bubbles into the wine as it is passes through the aerator. However, to the best of the inventor's knowledge, nobody has developed an adjustable wine aerator that adjustably uses the Venturi effect.

Different types of wines can benefit from different levels of aeration. There remains a need, therefore, for an adjustable Venturi-type wine aerator.

### BRIEF SUMMARY OF THE INVENTION

The present invention specifically addresses and alleviates the above mentioned deficiencies associated with the prior art. More particularly, and in one aspect, the present invention resides in an improved venturi-based wine aerator having a fluid passage that includes a throat portion for drawing air bubbles into the passing wine, the improvement comprising a first air introduction system leading to the throat portion of the fluid passage via a first output aperture having a first cross-sectional area for producing air bubbles of a first size, and a second air introduction system leading to the throat portion of the fluid passage via a second output aperture having a second cross-sectional area that is greater than the first cross-sectional area for producing air bubbles of a second larger size.

In another aspect, the present invention resides in a wine aerator that produces variable size bubbles comprising: a fluid passage that includes a throat portion for creating a lower pressure and drawing air bubbles into the passing wine according to the Venturi principle; a first plurality of air channels of first cross-sectional area permitting ambient air to reach the throat portion of the fluid passage for producing air bubbles of a first size; a second plurality of air channels of second cross-sectional area that is greater than the first cross-sectional area permitting ambient air to reach the throat portion of the fluid passage for producing air bubbles of a second larger size; a third plurality of air channels of third cross-sectional area that is greater than the first and second cross-sectional areas permitting ambient air to reach the throat portion of the fluid passage for producing air bubbles of a third larger size; and a rotating selector that permits ambient air to pass into a selected one of the first, second, and third plurality of air channels and inhibits air from passing into unselected ones of the first, second, and third plurality of air channels.

In another aspect, the present invention resides in an adjustable wine aerator comprising: a body having an outside and a fluid passage extending from an upper inlet end of the body to a lower outlet end of the body for permitting wine to pass through the fluid passage under the force of gravity, the body further having an upper body portion that is configured to provide the fluid passage with an upper wine inlet portion of enlarged cross-sectional area and a lower body portion that is configured to provide the fluid passage with a lower throat portion of reduced cross-sectional area whereby the wine passing through the fluid passage from the upper wine inlet portion and then through the lower throat portion exhibits an inherent increase in speed and associated reduction in pressure within the lower throat portion; a first air introduction system extending inward from the outside, through the lower body portion, and into the lower throat portion of the fluid passage via a first output aperture having a first cross-sectional area; and a second air introduction system extending from the outside of the body, through the lower body portion, and into the lower throat portion of the fluid passage via a second output aperture having a second cross-sectional area that is greater than the first cross-sectional area; whereby air pulled through the first air introduction system and mixed with the wine passing through the lower throat portion creates bubbles of a first size corresponding to the first cross-sectional area of the first output aperture, and air pulled through the second air introduction system and mixed with the wine passing through the lower throat portion creates bubbles of a second larger size corresponding to the second cross-sectional area of the second output aperture.

Other embodiments are more fully described below.

While the apparatus and method has or will be described for the sake of grammatical fluidity with functional explanations, it is to be expressly understood that the claims, unless expressly formulated under 35 USC §112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC §112 are to be accorded full statutory equivalents under 35 USC §112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIGS. 1A to 5B relate to a first adjustable wine aerator 10 according to a first embodiment;

FIGS. 6 to 8 relate to a second adjustable wine aerator 110 according to a second embodiment; and

FIGS. 9 to 18 relate to a third adjustable wine aerator 210 according to a third preferred embodiment.

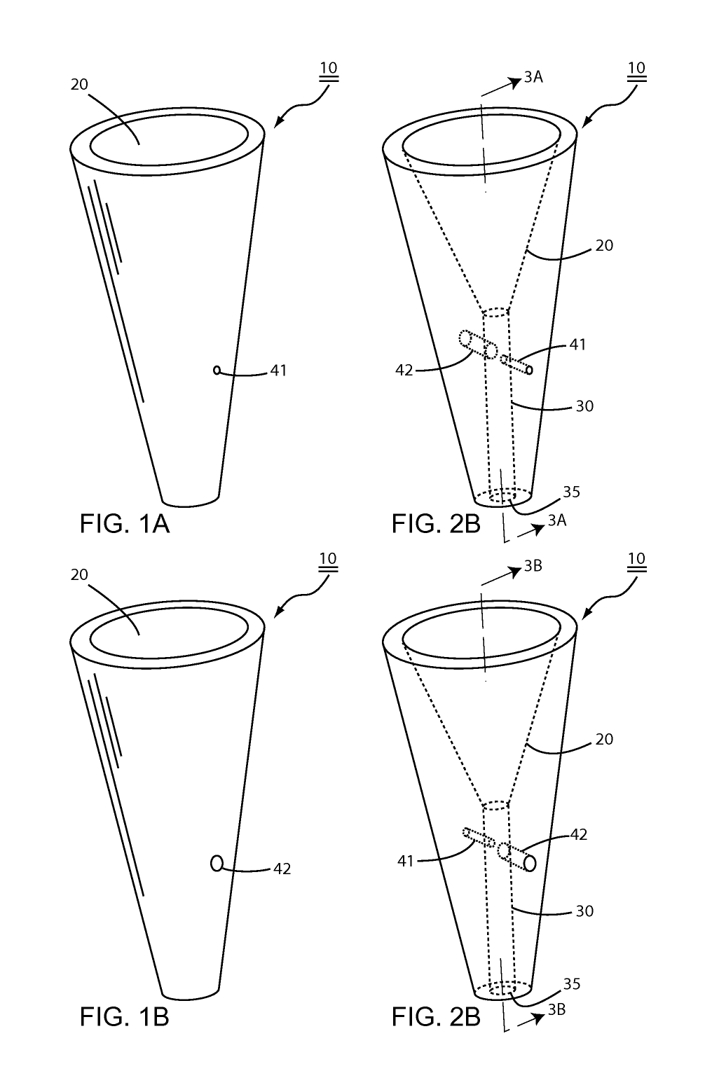

### FIRST EMBODIMENT OF FIGS. 1A TO 5B

FIGS. 1A and 1B are perspective views of the opposite sides of a first adjustable wine aerator 10, one side having a small air passage 41 and the opposite side having a large air passage 42;

FIGS. 2A and 2B are partially transparent perspective views of the first adjustable wine aerator 10 of FIGS. 1A and 1B, respectively, showing how small and large air passages 41, 42 connect to a constricted fluid passage 30;

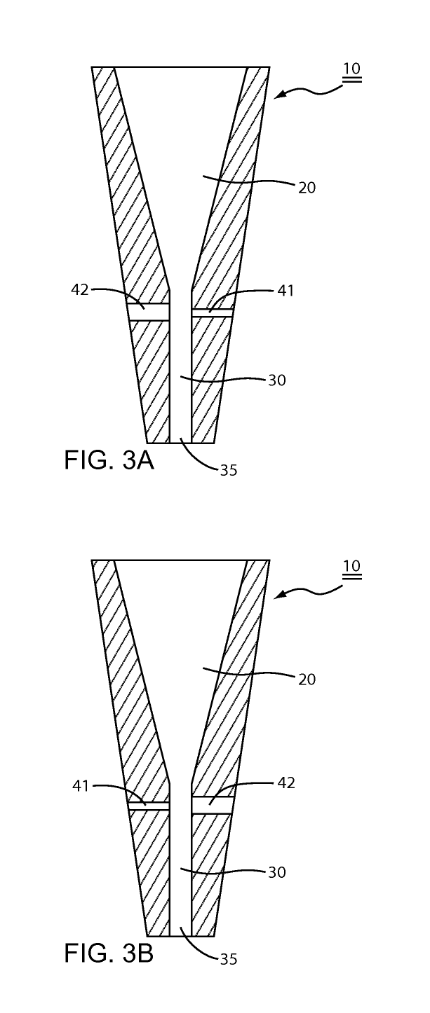

FIGS. 3A and 3B are a cross-sectional views of FIGS. 2A and 2B, respectively, taken along section lines 3A-3A and 3B-3B;

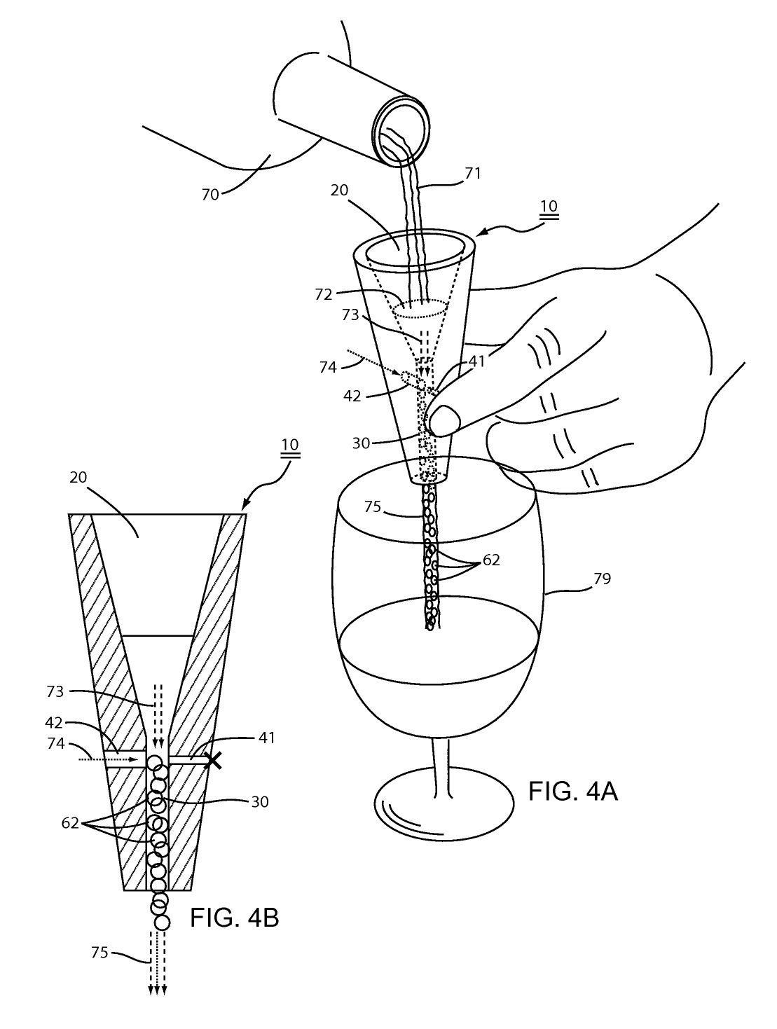

FIG. 4A is a perspective view of the first adjustable wine aerator 10 in use, with wine 71 being poured therein, the small air passage 41 blocked by the user's finger, and aerated wine 75 exiting the bottom;

FIG. 4B is a cross-sectional view of the first adjustable wine aerator 10 of FIG. 4A showing how the large air passage 42 draws air 74 from the outside and introduces large air bubbles 62 into the passing wine 73;

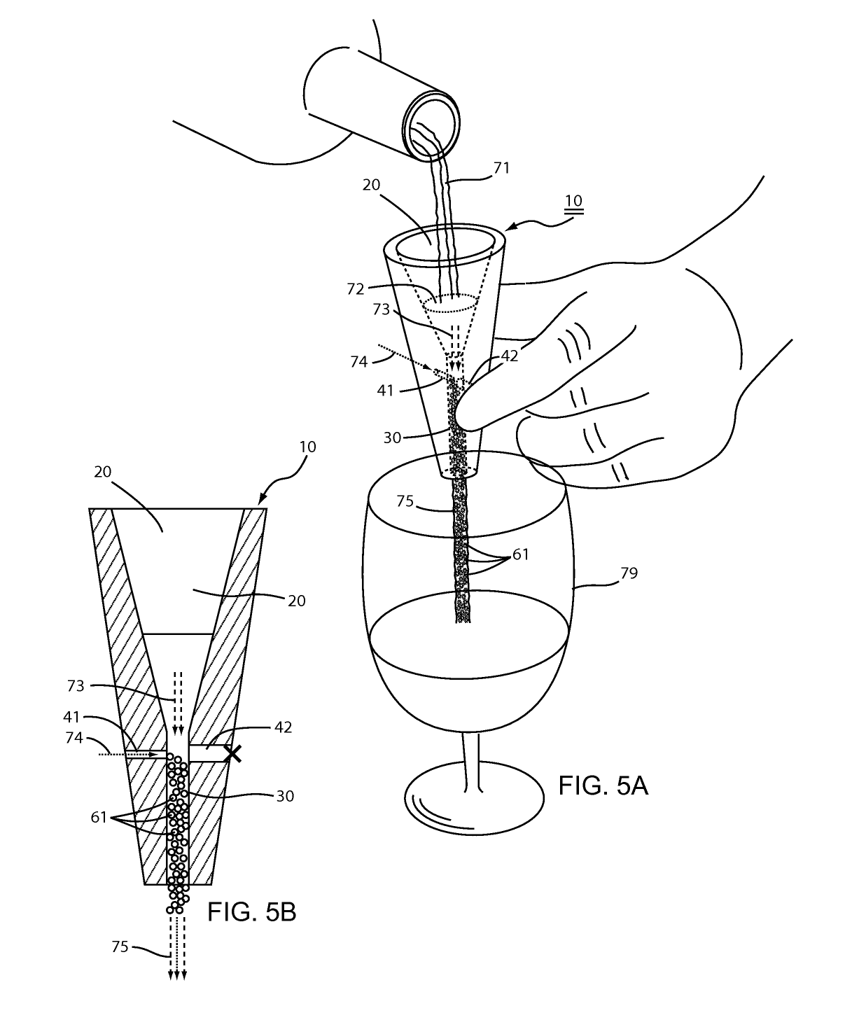

FIG. 5A is a perspective view of the first adjustable wine aerator 10 in use, with wine 71 being poured therein, the large air passage 42 blocked by the user's finger, and aerated wine 75 exiting the bottom; and

FIG. 5B is a cross-sectional view of the first adjustable wine aerator 10 of FIG. 5a showing how the small air passage 41 draws air 74 from the outside and introduces small air bubbles 61 into the passing wine 73.

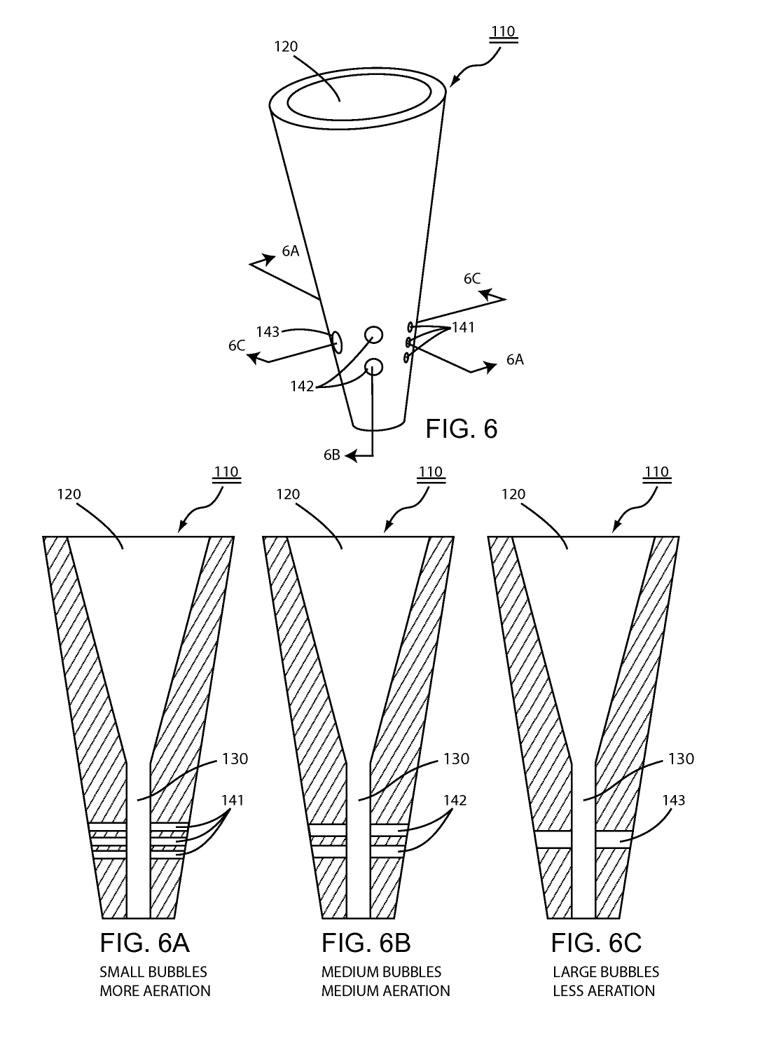

### SECOND EMBODIMENT OF FIGS. 6 TO 8

FIG. 6 is a perspective view of a second adjustable wine aerator 110 having three angularly separated sets of air inlet passages including three small air inlet passages 141, two medium size air inlet passages 142, and one large air inlet passage 143;

FIGS. 6A, 6B, and 6C are an angular succession of cross-sectional views of FIG. 6, respectively, taken along section lines 6A-6A, 6B-6B, and 6C-6C.

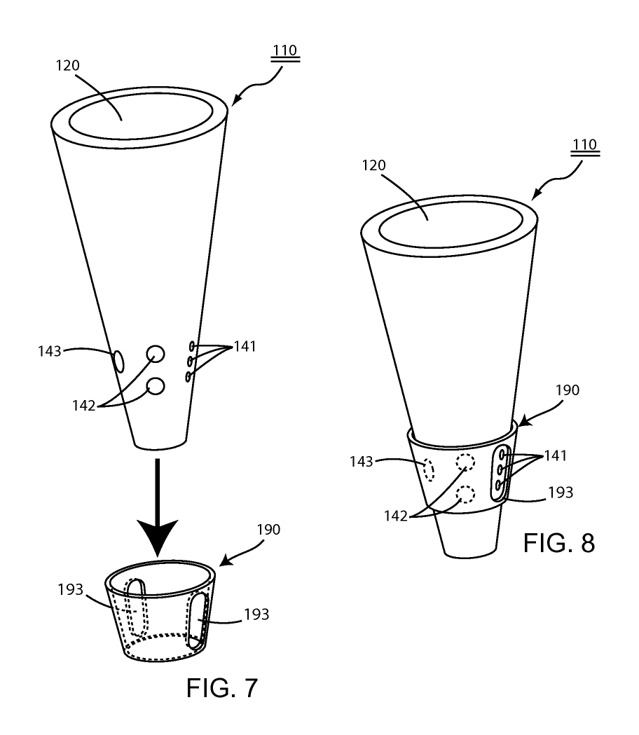

FIG. 7 shows how the second aerator 110 may be combined with a selection sleeve 190 that fits on the outside of the aerator 110; and

FIG. 8 shows how the selection sleeve 190 is rotatable to a desired position relative to the small, medium, and large air passages 141, 142, 143;

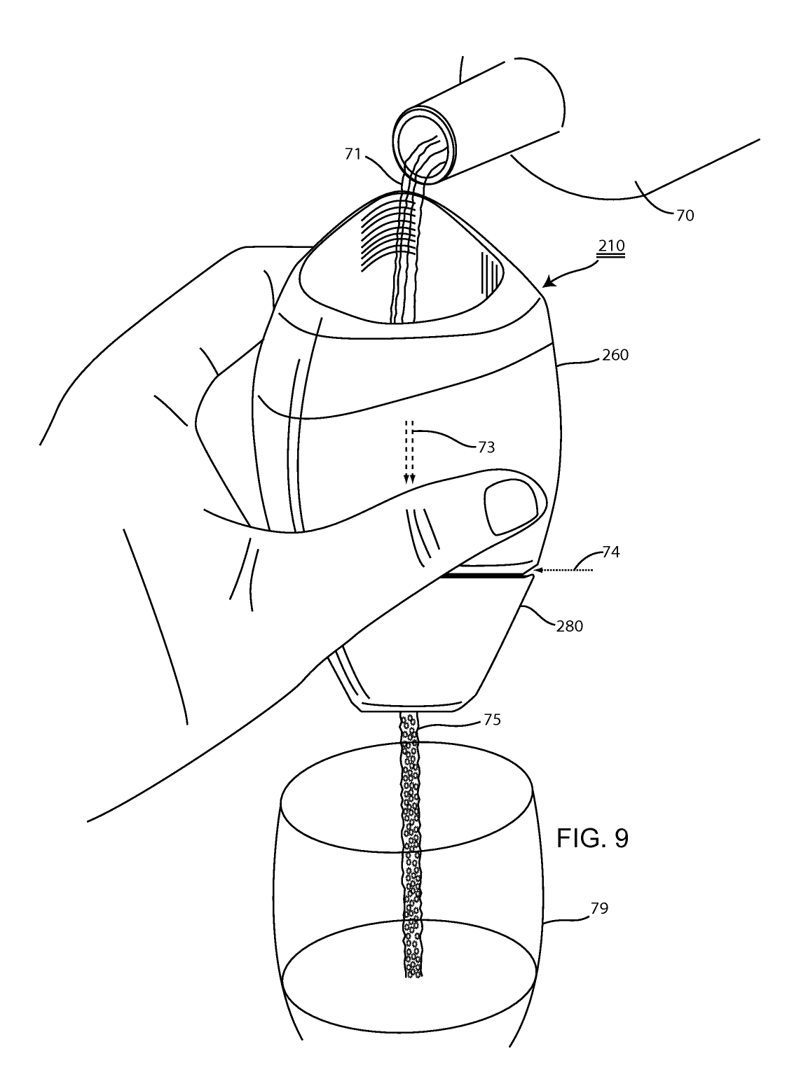

### THIRD PREFERRED EMBODIMENT OF FIGS. 9 TO 18

FIG. 9 is a perspective view of a third preferred adjustable wine aerator 210 in use, with wine 71 being poured into the aerator's top, with wine 73 passing through the aerator's interior, with air 74 being drawing into the aerator's side, and with aerated wine 74 exiting the aerator's bottom;

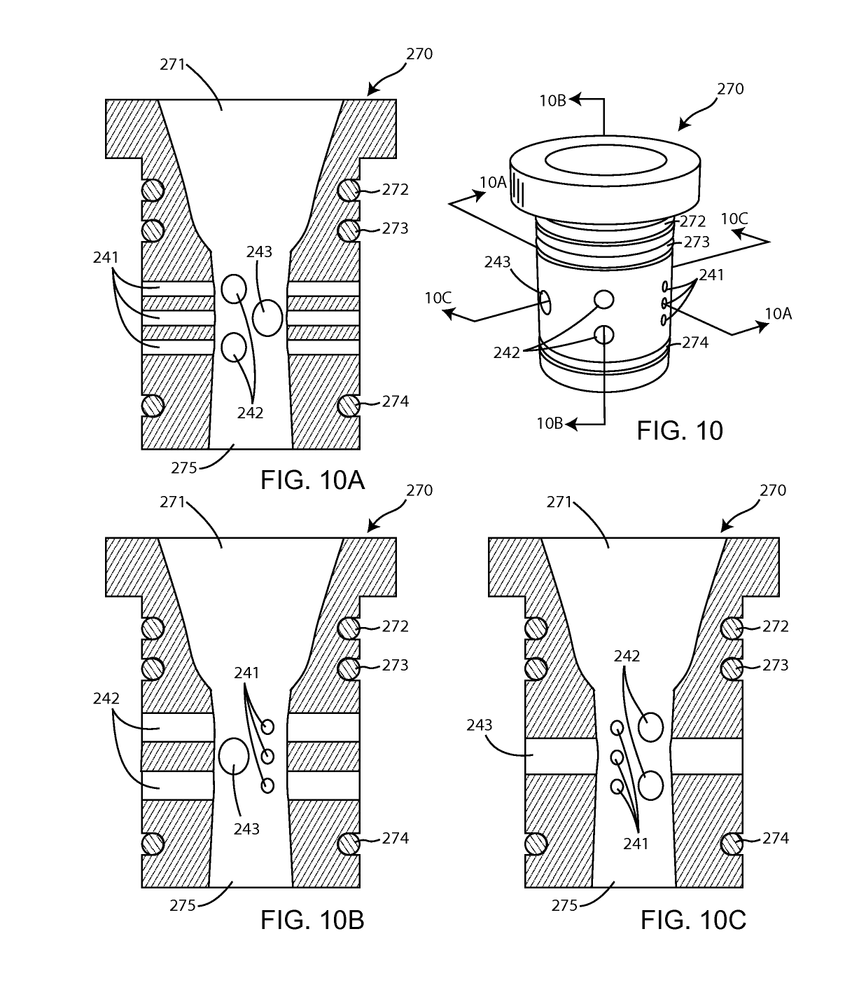

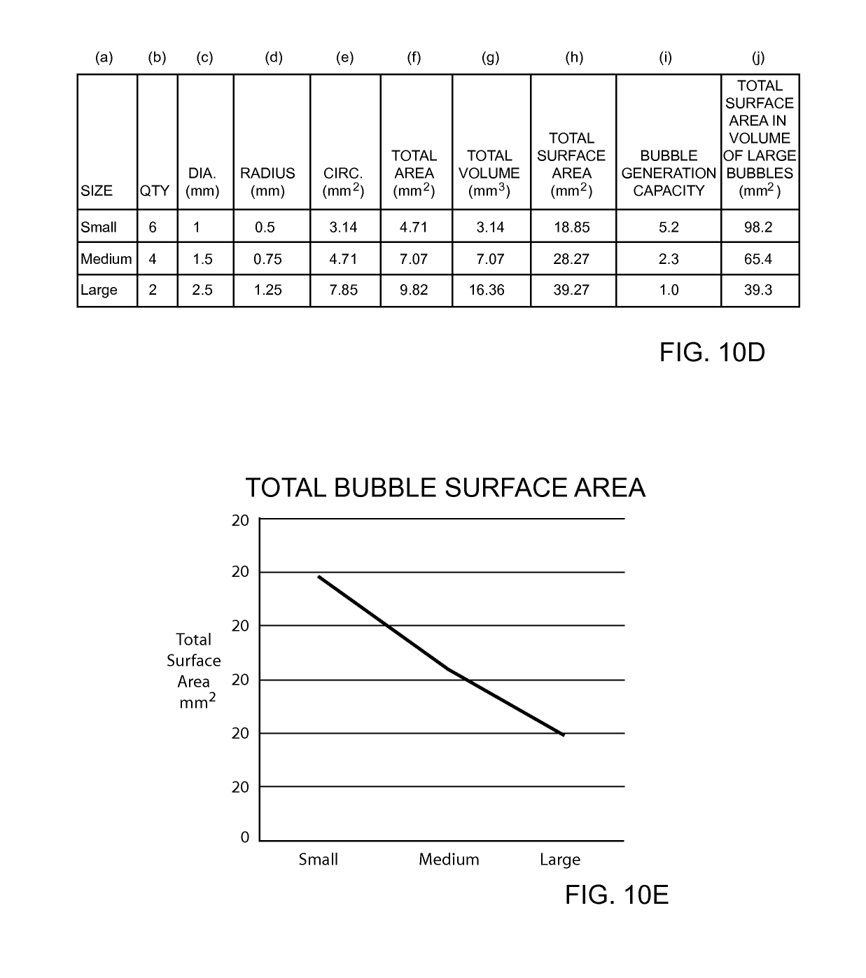

FIG. 10 is a perspective view of an aeration cylinder 270 that is located inside of the adjustable wine aerator 210 of FIG. 9, the aeration cylinder 270 having three angularly separated sets of air inlet passages including six small air passages 241 (three on each side), four medium air passages 242 (two on each side), and two large air passage 243 (one on each side);

FIGS. 10A, 10B, and 10C are an angular succession of cross-sectional views taken along section lines 10A-10A, 10B-10B, and 10C-10C of FIG. 10, respectively;

FIG. 10D is a table that, focusing on columns (a) to (h), shows the total surface area produced by 6 small, 4 medium, and 2 large air bubbles, and focusing on columns (i) and (j), shows “bubble generation capacity” and the total surface area (relating to aeration) for small, medium, and large bubbles within the volume of two large bubbles;

FIG. 10E is a graph of total bubble surface area (column i) as a function of small, medium, and large air passages;

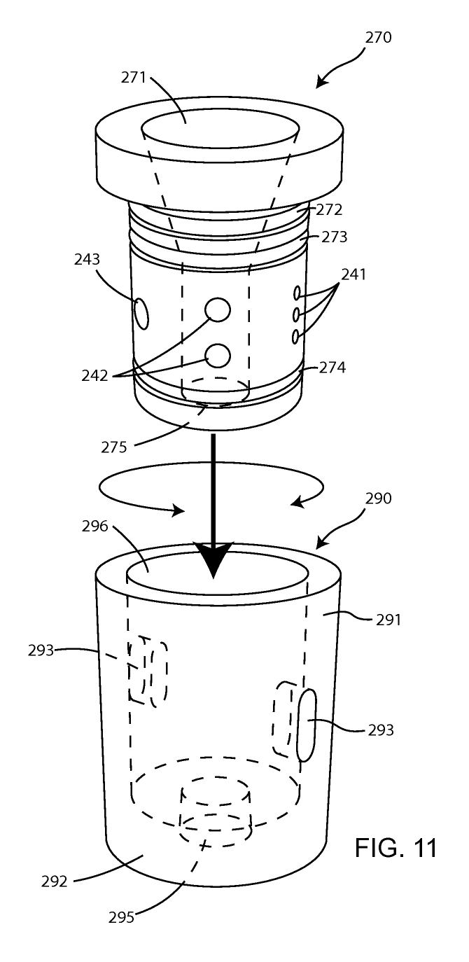

FIG. 11 is an exploded perspective view of the aeration cylinder 270 of FIG. 9 and a passage selection sleeve 290 that engage and rotate relative to one another;

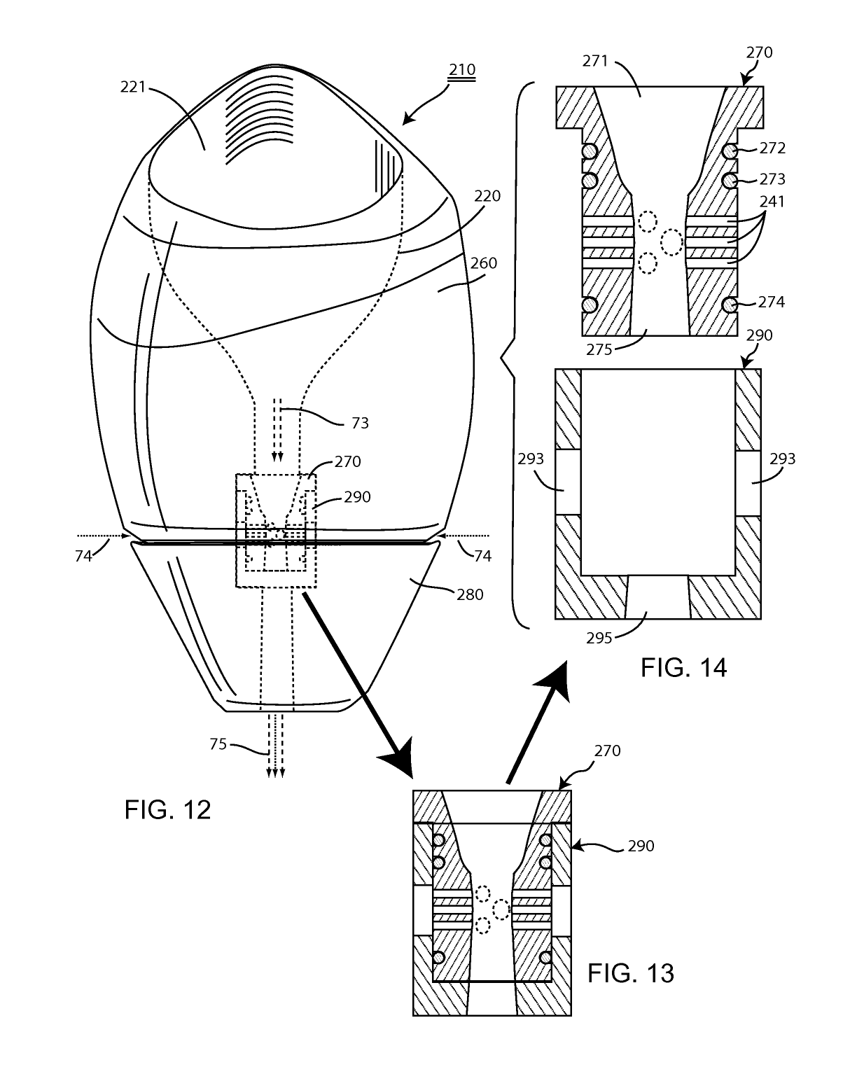

FIG. 12 is a partially transparent side view of the wine aerator 210 of FIG. 9 showing the internal location of the aeration cylinder 270 and the passage selection sleeve 290;

FIG. 13 is a cross-sectional view that focuses on the aeration cylinder 270 and the passage selection sleeve 290 of FIG. 12;

FIG. 14 is a cross-sectional exploded view of the aeration cylinder 270 and the passage selection sleeve 290 of FIG. 13;

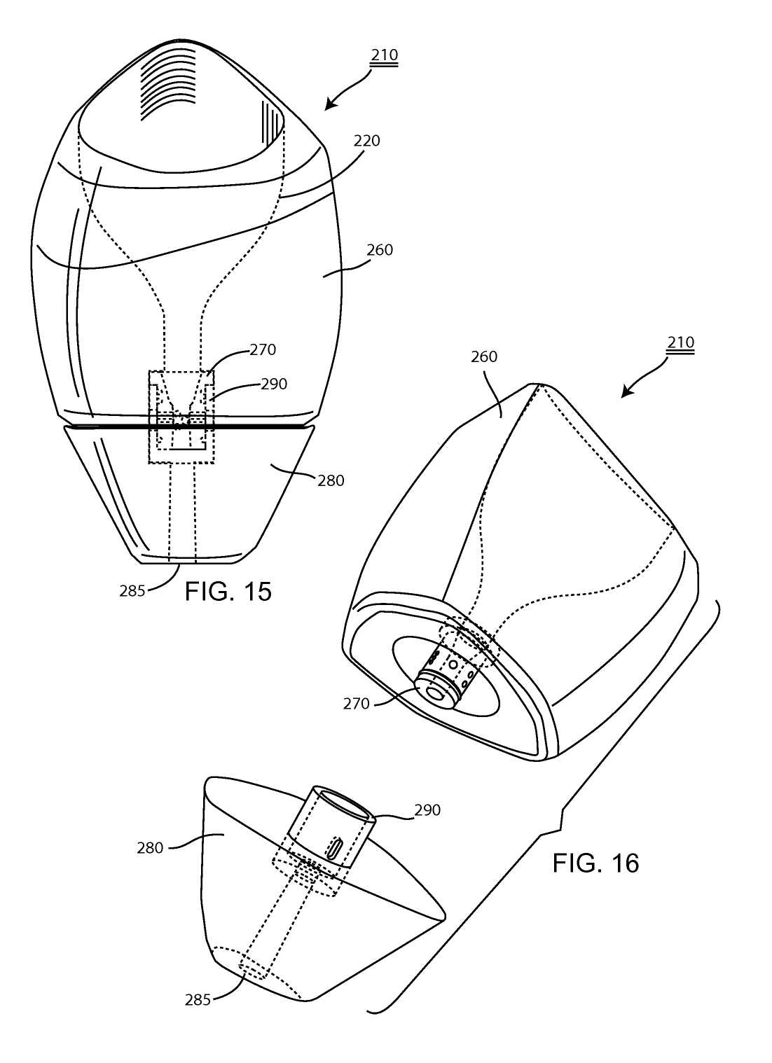

FIG. 15 is a partially transparent side view of the wine aerator 210 that emphasizes the upper body portion 260 and the lower body portion 280;

FIG. 16 is an exploded perspective view of the wine aerator 210 of FIG. 15 after the upper body portion 260 has been separated from then lower body portion 280 showing how they connect to one another via the aeration cylinder 270 the passage selection sleeve 290;

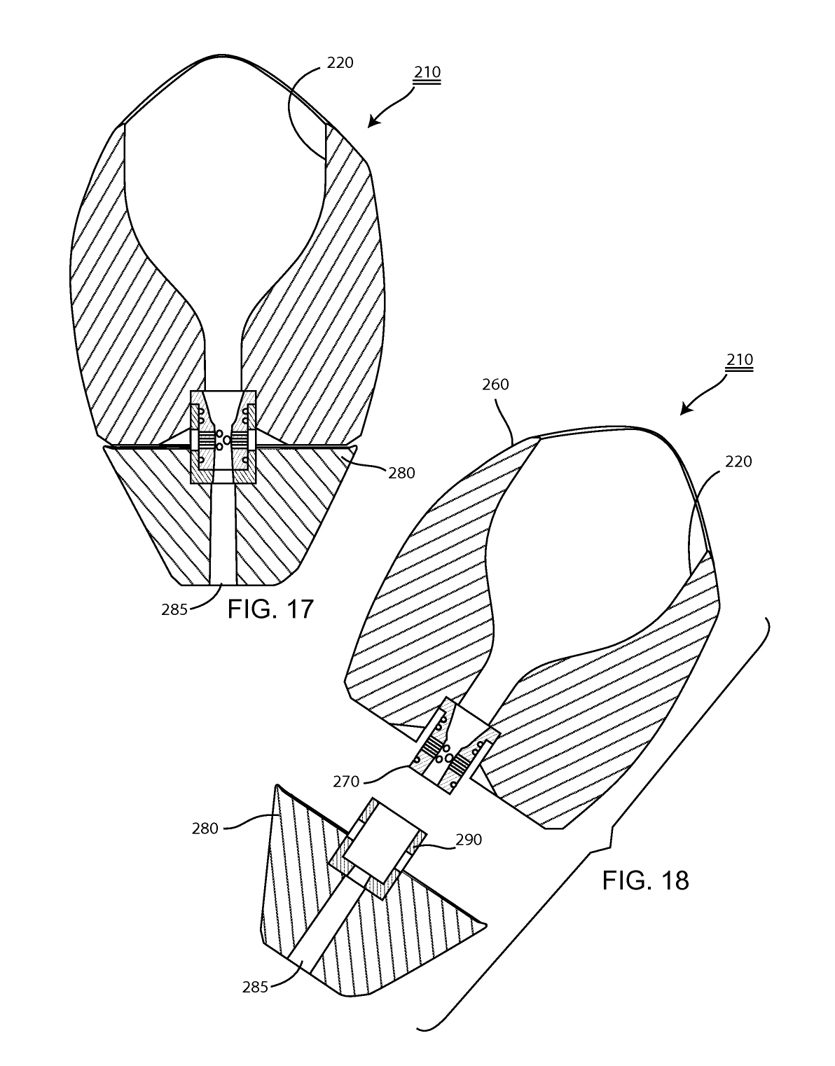

FIG. 17 is a cross-sectional side view of the wine aerator 210 that emphasizes the upper body portion 260 and the lower body portion 280; and

FIG. 18 is an exploded cross-sectional view of the wine aerator 210 of FIG. 17 after the upper body portion 260 has been separated from then lower body portion 280 showing how they connect to one another via the aeration cylinder 270 the passage selection sleeve 290.

### DETAILED DESCRIPTION OF THE PREFERRED EMBODIMENTS

The following description presents three embodiments of the invention, starting with a first embodiment that presents the underlying concepts in a simple device having only two levels of aeration, a more complex second embodiment having three levels of aeration, and a third and currently preferred embodiment corresponding to the early planning stages of a commercial product.

### First Embodiment

FIGS. 1A to 5B show an adjustable wine aerator 10 according to the first embodiment (sometimes hereafter “first aerator 10”). The first aerator 10 can be made of any suitable material and in any desired manner—turned wood, CNC machined metal, injection molded plastic, etc.

The first aerator 10 can introduce small air bubbles 61 or large air bubbles 62 to provide for two different levels of aeration. In theory, the first aerator 10 can simultaneously introduce small and large air bubbles into the wine for a third intermediate level of aeration, but for the sake of simplicity, the remaining description will only discuss two discrete levels based on the user's selection of one or the other.

Jumping ahead for the moment, FIGS. 4A and 4B provide the best context for understanding this first embodiment. In both figures, the first aerator 10 is aerating wine 71 that is being poured from a wine bottle 70 into a glass 79. The wine 71 is simply traveling downward through the aerator 10 under the force of gravity. In FIG. 4A, the first aerator 10 is producing large air bubbles 62 (least aeration). In FIG. 4B, the first aerator 10 is producing small air bubbles 61 (most aeration).

FIGS. 1A and 1B show opposite sides of the first aerator 10. As shown, one side of the first aerator 10 has a small air inlet 41 and the other side has a large air inlet 42. The two air inlets 41, 42 may be regarded as separate air introduction systems. In operation, the user covers or blocks one of the two air inlets 41, 42 such that the other air inlet is left open for purposes of aeration. The different cross-sectional areas of the small and large air inlets 41, 42 will uniquely produce different sized air bubbles during aeration.

FIGS. 2A and 2B are partially transparent views of the first aerator 10, corresponding to FIGS. 1A and 1B respectively. FIGS. 3A and 3B are cross-sectional views of the first aerator 10, taken along section lines 3A-3A and 3B-3B, and also correspond to FIGS. 1A and 1B respectively. FIGS. 2A, 2B and 3A, 3B show how the first aerator 10 has a fluid passage formed by an upper fluid chamber 20 and a lower fluid passage 30 or throat section that are in fluid communication with one another. As shown, the upper fluid chamber 20 is generally funnel shaped, or tapered, such that it has a relatively large cross-sectional area at its upper end for receiving wine that is poured from a wine bottle 70 and for temporarily acting as a reservoir while the wine is poured into the aerator 10. At the same time, the lower fluid passage 30 has a reduced cross-sectional area, thereby providing the overall fluid passage with a classic Venturi configuration. The width and height proportions of the upper fluid chamber 20 would be derived as an engineering compromise between providing a sufficient head of pressure (vertical) and providing for reasonably sized entry for pouring (width).

As further shown in FIGS. 2A, 2B and 3A, 3B, the small and large air inlets 41, 42 connect radially-inward to the lower fluid passage 30 at or below its connection to the upper fluid chamber 20. As a result, when wine 71 is poured into the first aerator 10 as shown in FIGS. 4A, 4B and 5A, 5B, a volume of wine 72 temporarily collects in the upper fluid chamber 20. From there, a downward wine flow 73 travels from the upper fluid chamber 20 to the lower fluid passage 30 and passes by the small or large air inlets 41, 42. At that point, air 74 is drawn into the passing wine 73 (having an accelerated velocity and a reduced pressure due to the Venturi effect) to produce an aerated wine stream 75 having small air bubbles 61 or large air bubbles 62, depending on which air inlet 41, 42 was covered by the user.

When pouring wine 71, the user can choose different levels of aeration by simply covering one of the air inlets 41, 42 and leaving open the other. In FIGS. 4A and 4B (as suggested by the “X”), the user's finger is covering the small air inlet 41 and thereby placing it in a closed state such that large air bubbles 62 are introduced into the aerated wine stream 75 via the large air inlet 42 that remains in an open state. In FIGS. 5A and 5B, by contrast, the user is covering the large air inlet 42 such that small air bubbles 61 are introduced into the aerated wine stream 75 via the small air inlet 41. The small air bubbles 61 provide more surface area and expose more air to the wine, as compared with the large air bubbles 62, because many more small bubbles are produced in a given amount of time and in a given volume of passing wine 73

### Second Embodiment

FIGS. 6 to 8 show a second wine aerator 110 according to a second embodiment. FIG. 6 is a perspective view of the second aerator 110 and FIGS. 6A, 6B, and 6C are an angular succession of cross-sectional views, respectively, taken along section lines 6A-6A, 6B-6B, and 6C-6C of FIG. 6.

The second aerator 110 is structurally and functionally similar to the first aerator 10. For example, the first aerator has an upper fluid chamber 20 that is funnel shaped and a lower fluid passage 30 that accelerates the wine and reduces it pressure according to the Venturi effect. In like fashion, the second aerator 110 of FIG. 6 has an upper fluid chamber 120 that is funnel shaped and a lower fluid passage 130 that functions in the same manner. However, while the first aerator has only one small air passage 41 and only one large air passage 42, the second aerator 110 uniquely has a plurality of small, medium, and large air passages 141, 142, 143.

In more detail, the second aerator 110 has six small air passages 141 (three on each side), four medium air passages 142 (two on each side), and two large air passages 143 (one on each side). As suggested by FIG. 6 and the three related cross-sections, the small, medium, and large air passages 141, 142, 143 preferably have an angular separation of sixty degrees so that they are evenly spaced around the circumference of the aerator 110. As also suggested by the figures, the small, medium, and large air passages 141, 142, 143 are preferably sized as to present a substantially equal cross-sectional area to the lower fluid passage 130. In other words, the sum of the cross-sectional areas of the six small air passages 141 is substantially equal to the sum of the cross-sectional areas of the four medium air passages 142 and to the sum of the two cross-sectional areas of the two large air passages 143.

When pouring wine into the second wine aerator 210, the user can nominally choose one of three different levels of aeration by leaving open a selected set of the small, medium, or large air passages 141, 142, 143, and covering the unselected passages. A particularly dexterous user might be able to cover the unselected passages with their fingers, but it should be readily apparent that a mechanical cover one kind or another would simplify operation. As suggested by FIGS. 7 and 8, for example, the second aerator 110 could be combined with a frustoconical selection sleeve 190 that closely fits the outside of the aerator 110 and is rotatable to a desired position relative to the small, medium, and large air passages 141, 142, 143. As shown, the selection sleeve 190 has an opposed pair of air openings 193 that, when aligned, leave open a selected set of air passages 141, 142, or 143, while the remainder of the sleeve 190 between the air openings 193 covers the two unselected sets of air passages.

The selection sleeve 190 could have a friction fit with the second aerator 110. Or, the second aerator 110 could have an annular groove (not shown) that receives an inwardly extending ridge and helps hold the sleeve sleeve 190 to the outside of the aerator 110.

The illustrated selection sleeve 190 is just one of many possible mechanisms for opening and closing the air passages. In fact, any number of mechanisms could be used to selectively open and close, or cover and uncover, the air passages 141, 142, 143.

### THIRD PREFERRED EMBODIMENT

FIGS. 9 to 18 relate to an adjustable wine aerator 210 according to a third preferred embodiment (sometimes hereinafter “third aerator 210”). The inventor was designing this particular embodiment for future release as a commercial product.

The third aerator 210 of FIG. 9, like the first aerator 10 of FIGS. 1A to 5B, and the second aerator 110 of FIGS. 6 to 8, is designed for aerating wine 71 that is being poured from a wine bottle 70 into a receptacle such as a glass 79. As before, the wine 71 is poured into the aerator 210 from above and exits the aerator from below as an aerated wine stream 75. The third aerator 210, though, uniquely has an upper body portion 260 and a lower body portion 280 that rotate relative to one another somewhat hide the air passages. In more detail, the air 74 that will be introduced into the wine flow 73 via the air passages is pulled into an annular gap (not separately numbered) located between the two body portions 260, 280.

FIG. 10 and the related cross-sections of FIGS. 10A, 10B, and 10C will help clarify the construction and overall operation of the third preferred aerator 210, especially when considered in light of the second aerator 110 of FIG. 6 and the related cross-sections of FIGS. 6A, 6B, and 6C.

FIG. 10 is a perspective view of an aeration cylinder 270 that, as will become clear, is located inside of the third preferred aerator 210 of FIG. 7. FIGS. 10A, 10B, and 10C are an angular succession of cross-sectional views taken along section lines 10A-10A, 10B-10B, and 10C-10C of FIG. 10, respectively. As shown, the aeration cylinder 270 has three angularly separated sets of air passages including six small air passages 241 (three on each side), four medium air passages 242 (two on each side), and two large air passages 243 (one on each side). The aeration cylinder 270 also carries a number of O-rings, two O-rings 272, 273 near its upper end, and one O-ring 274 near its lower end. Finally, the aeration cylinder 270 includes an upper fluid chamber 271 and an axial fluid outlet 275.

The inventor believes that the aeration level can be varied by varying the total surface area of the air bubbles exposed to the wine. The exact total is difficult to quantify with mathematical certainty since the air bubbles may tend to be formed in a cylindrical boundary zone within the throat of the aeration cylinder 270, because initial air bubbles may interfere with the efficient formation of additional air bubbles further downstream, etc. However, we can estimate the relative aeration levels by starting with the diameter of the air passages and assuming that the air bubbles formed by such passages will efficiently fill a given volume of wine.

As presently preferred, the small, medium, and large air passages 241, 242, 243 have diameters of 1 mm, 1.5 mm, and 2.5 mm, respectively. The following table represents the surface area (A=4πr²) of a spherical air bubble formed by each such air passage:

| Size | Diameter (mm) | Radius (mm) | Surface Area (mm²) |
|---|---|---|---|
| Small | 1.0 | 0.5 | 3.142 |
| Medium | 1.5 | 0.75 | 7.069 |
| Large | 2.5 | 1.25 | 19.635 |

From the table above, it can be seen that a small air bubble has less surface area than a large air bubble. However, it is presently believed that the small air passages provide more aeration than the medium air passages which, in turn, provide more aeration than the large air passages because many more small (or medium) air bubbles are created within the same volume of wine during aeration. In other words, the total surface area of air exposed to the wine is greater with a lot of small air bubbles than with relatively few medium, or even fewer large bubbles. FIG. 10D is a table that, focusing on columns (a) to (h), shows the total surface area produced by 6 small, 4 medium, and 2 large air bubbles, respectively. Column (i) presents a concept called “bubble generation capacity” which are ratios relating to the total volume occupied by six small, four medium, and two large bubbles. Two large bubbles, of course, have a bubble generation capacity of 1.0, whereas four medium and six small bubbles have a bubble generation capacity of 2.3 (16.36/7.07) and 5.2 (16.36/3.14), respectively. The final column (j) represents the total surface area in the volume of two large bubbles, showing that more aeration is possible with small bubbles (98.2) then medium bubbles (65.4) then large bubbles (39.3). The actual number of bubbles and relative proportion of bubbles will likely vary due to real world complications, but the “small is more” characteristic and relative proportions are believed to be correct. Applicant also notes that the small is more characteristic is further enhanced by the fact that smaller bubbles have a lower bubble rise velocity, which means that once entrained in the wine, the smaller bubbles tend to stay there longer.

FIG. 10E is a graph of total bubble surface area (column i) as a function of small, medium, and large air passages. The main takeaway from FIG. 10E is that the aeration which relates to total surface area is most for the small air bubbles and least for the large air bubbles.

FIG. 11 is an exploded perspective view of the aeration cylinder 270 of FIG. 9 and an air passage selection sleeve 290 that engage and rotate relative to one another. FIG. 11 should be compared with FIGS. 7 and 8 for guidance. As shown, the air passage selection sleeve 290 includes a cylindrical wall 291 with two elongated air openings 293 (one on each side) and a bottom wall 292 with an axial fluid outlet 295. When the aeration cylinder 270 is slid downward into the air passage selection sleeve 290, then the two can be rotated relative to one another such that the opposing members of the small, medium, and large air passages 241, 242, 243 can be aligned with the two elongated air openings 293 of the air passage selection sleeve 290. As such, the aeration cylinder 270 and air passage selection sleeve 290 can be rotated until a selected one of the small, medium, and large air passages 241, 242, 243 are open, and the two unselected sets of air passages are closed.

The aeration cylinder 270 has a relatively close fit with the air passage selection sleeve 290. In addition, the O-rings 272, 273, 274 on the aeration cylinder 270 seal against the interior of the wall 291, both above and below the opposed air openings 293, thereby limiting the air that is available to the small, medium, and large air passages 241, 242, 243 to that which is available via the elongated air openings 293, and also inhibiting any wine that may enter that area from dripping after use.

FIGS. 12, 13, and 14 are a series of figures that are designed to show the internal location of the aeration cylinder 270 and related passage selection sleeve 290, and to provide more insight into the construction and overall operation of the third aerator 210. In particular, FIG. 12 is a partially transparent side view of the third aerator 210; FIG. 13 is a cross-sectional view that focuses on the aeration cylinder 270 and the passage selection sleeve 290 of FIG. 12; and FIG. 14 is a cross-sectional exploded view of the aeration cylinder 270 and the passage selection sleeve 290 of FIG. 13.

In FIGS. 12, 13, and 14, the upper and lower body portions 260, 280 have been rotated relative to one another such that the aeration cylinder 270 and related passage selection sleeve 290 have been placed in a desired alignment. In more detail, the aeration cylinder's small air passages 241 have been aligned with the selection sleeve's air openings 293. As a result, and as suggested by FIGS. 12, 13, and 14, the air 74 being drawn into the gap between the upper and lower body portions 260, 280 ultimately passes through the selection sleeve's air openings 293, then into the aeration cylinder's small air passages 241, and ultimately into the wine flow 73 to produced aerated wine 75.

FIGS. 15, 16 and 17, 18 are another series of figures that further clarify the construction and overall operation of the third preferred aerator 210. As shown in FIGS. 15 and 17, the third aerator's upper and lower body portions 260, 280 are closely situated to one another when assembled. However, as shown in FIGS. 16 and 18, the upper and lower body portions 260, 280 can be separated from one another (e.g. for cleaning) by pulling the two axially away from one another. In more detail, the upper body portion 260 includes the aeration cylinder 270, and the lower body portion 280 includes the selection sleeve 290. As a result, the upper and lower body portions 260, 280 can be connected together and rotated relative to one another via the mechanical connection between the aeration cylinder 270 and the selection sleeve 290.

At present, the inventor contemplates that the aeration cylinder 270 and selection sleeve 290 will be formed from CNC machined aluminum, and that the upper and lower body portions 260, 280 will be formed from injection molded plastic, preferably a clear plastic such as acrylic. The present intent is to use an over-molding process where the upper body portion 260 is permanently formed onto and around the aeration cylinder 270 with suitable injection molding equipment and related tools, and where the lower body portion is permanently formed onto and around the selection sleeve 290.

In the third preferred aerator 210, the upper and lower body portions 260, 280 have a generally triangular profile lateral to the flow axis such that suitable markings can be provided to the alignment of the selection sleeve's air opening with the small, medium, and large air passages 241, 242, 243. For example, the upper body portion 260 may have an indicator arrow on one of its three faces while the lower body portion 280 has the words “small,” “medium,” and “large” on each of its three faces, or similar graphics regarding bubble size.

Other modifications are currently under consideration. In the embodiments described above, the small and medium air passages are provided in a vertically stacked arrangement. In FIG. 11, for example, the three small air passages 241 and the two medium air passages 242 are vertically aligned. The inventor presently believes that the first air passage may interrupt the laminar flow of wine presented to the next air passage, or passages, such that the efficient creation of bubbles may be substantially enhanced by horizontally offsetting the air passages relative to one another. The possible arrangements include a diagonal configuration, a spiral configuration, etc. If modified in this manner, the elongated air openings 293 (one on each side) of the air passage selection sleeve 290 would be similarly modified to have a diagonal or spiral shape, rather than a vertical shape as shown in FIG. 11.

While the particular process that is shown and disclosed in detail is fully capable of obtaining the objects and providing the advantages herein before stated, it is to be understood that it merely illustrates the presently preferred embodiment of the invention and that no limitations are intended to be confined to the details of the preferred equipment or illustrated process shown and described herein, other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. In an improved venturi-based wine aerator having a fluid passage that includes a throat portion for drawing air bubbles into the passing wine, the improvement comprising:
a first air introduction system leading to the throat portion of the fluid passage via a first output aperture having a first cross-sectional area for producing air bubbles of a first size; and
a second air introduction system leading to the throat portion of the fluid passage via a second output aperture having a second cross-sectional area that is greater than the first cross-sectional area for producing air bubbles of a second larger size.

2. The improved venturi-based wine aerator of claim 1 further comprising:
a selector that permits air to pass into a selected one of the first and second air introduction systems and inhibits air from passing into an unselected one of the first and second air introduction systems.

3. The improved venturi-based wine aerator of claim 1 further comprising:
a third air introduction system leading to the throat portion of the fluid passage via a third output aperture having a third cross-sectional area that is greater than the first and second cross-sectional areas for producing air bubbles of a third larger size.

4. The improved venturi-based wine aerator of claim 3 further comprising:
a selector that permits air to pass into a selected one of the first, second, and third air introduction systems and inhibits air from passing into unselected ones of the first, second, and third air introduction systems.

5. A wine aerator that produces variable size bubbles comprising:
a fluid passage that includes a throat portion for creating a lower pressure and drawing air bubbles into the passing wine according to the Venturi principle;
a first plurality of air channels of first cross-sectional area permitting ambient air to reach the throat portion of the fluid passage for producing air bubbles of a first size;
a second plurality of air channels of second cross-sectional area that is greater than the first cross-sectional area permitting ambient air to reach the throat portion of the fluid passage for producing air bubbles of a second larger size;
a third plurality of air channels of third cross-sectional area that is greater than the first and second cross-sectional areas permitting ambient air to reach the throat portion of the fluid passage for producing air bubbles of a third larger size; and
a rotating selector that permits ambient air to pass into a selected one of the first, second, and third plurality of air channels and inhibits air from passing into unselected ones of the first, second, and third plurality of air channels.

6. The wine aerator of claim 5 wherein the first plurality of air channels comprises three channels of small diameter, the second plurality of air channels comprises two air channels of intermediate diameter, and third plurality of air channels comprises one channel of large diameter.

7. The wine aerator of claim 5
wherein the first plurality of air channels comprises six channels of small diameter and where three are on one side of the throat portion and three are on the other side of the throat portion, the second plurality of air channels comprises four air channels of intermediate diameter and where two are on one side of the throat portion and two are on the other side of the throat portion, and third plurality of air channels comprises two channels of large diameter and where one is on one side of the throat portion and one is on the other side of the throat portion; and
wherein the rotating selector permits ambient air to pass into a selected one of the first, second, and third plurality of air channels and inhibits air from passing into unselected ones of the first, second, and third plurality of air channels.

8. The wine aerator of claim 7 wherein the rotating selector comprises a cylindrical sleeve having a solid wall portion and an opposed pair of apertures, the cylindrical sleeve surrounding and rotating relative to the first, second, and third plurality of air channels, the opposed pair of apertures aligning with a selected one of the first, second, and third plurality of air channels, and the solid wall portion of the cylindrical sleeve simultaneously covering unselected ones of the first, second, and third air channels.

9. An adjustable wine aerator comprising:
a body having an outside and a fluid passage extending from an upper inlet end of the body to a lower outlet end of the body for permitting wine to pass through the fluid passage under the force of gravity, the body further having an upper body portion that is configured to provide the fluid passage with an upper wine inlet portion of enlarged cross-sectional area and a lower body portion that is configured to provide the fluid passage with a lower throat portion of reduced cross-sectional area whereby the wine passing through the fluid passage from the upper wine inlet portion and then through the lower throat portion exhibits an inherent increase in speed and associated reduction in pressure within the lower throat portion;
a first air introduction system extending inward from the outside, through the lower body portion, and into the lower throat portion of the fluid passage via a first output aperture having a first cross-sectional area; and
a second air introduction system extending from the outside of the body, through the lower body portion, and into the lower throat portion of the fluid passage via a second output aperture having a second cross-sectional area that is greater than the first cross-sectional area;
whereby air pulled through the first air introduction system and mixed with the wine passing through the lower throat portion creates bubbles of a first size corresponding to the first cross-sectional area of the first output aperture, and air pulled through the second air introduction system and mixed with the wine passing through the lower throat portion creates bubbles of a second larger size corresponding to the second cross-sectional area of the second output aperture.

10. The adjustable wine aerator of claim 9 wherein the first and second air introduction systems have input ends that may be selectively opened and closed.

11. The adjustable wine aerator of claim 10 wherein the aerator is configured such that a user may place a selected one of the input ends of the first and second air introduction systems into an open state and place an unselected one of the input ends of the first and second air introduction systems into a close state.

12. The adjustable wine aerator of claim 11 wherein the input ends of the first and second air introduction systems are accessible on the outside of the body such that a user may selectively place the input ends of the first and selected air introductions systems into an open and close state with a portion of the user's hand.

13. The adjustable wine aerator of claim 9 further comprising:
a port selector that permits air to pass into an input end of a selected one of the first and second air introduction systems and inhibits air from passing into an input end of an unselected one of the first and second air introduction systems.

14. The adjustable wine aerator of claim 13 wherein the port selector comprises a cylindrical sleeve having a solid wall portion and an aperture, the cylindrical sleeve surrounding and rotating relative to the lower body portion, the aperture of the cylindrical sleeve aligning with the input end of a selected one of the first and second air introduction systems, and the solid wall portion of the cylindrical sleeve simultaneously covering the input end of the unselected one of the first and second air introduction systems.

15. The adjustable wine aerator of claim 9 wherein
the first air introduction system comprises a first plurality of output apertures having a first total cross-sectional area, and the second air introduction system comprises a second plurality of output apertures having a second total cross-sectional area, and
the first and second total cross-sectional areas of the first and second output apertures are substantially equal.

16. The adjustable wine aerator of claim 9 further comprising a third air introduction system extending from the outside of the body, through the lower body portion, and into the lower throat portion of the fluid passage via a third output aperture having a third cross-sectional area that is greater than the second cross-sectional area.

17. The adjustable wine aerator of claim 16 wherein
the first air introduction system comprises a first plurality of output apertures having a first total cross-sectional area, the second air introduction system comprises a second plurality of output apertures having a second total cross-sectional area, and the third air introduction system comprises a third plurality of output apertures having a third total cross-sectional area, and
the first, second, and third total cross-sectional areas of the first, second, and third output apertures are substantially equal.

18. The adjustable wine aerator of claim 17
wherein lower throat portion of the fluid passage has an axis;
wherein the first plurality of output apertures of the first air introduction system are provided as a pair of input ends and corresponding output apertures that are radially opposed to one another relative to the axis in the lower throat portion of the fluid passage;
wherein the second plurality of output apertures of the second air introduction system are provided as a pair of input ends and corresponding output apertures that are radially opposed to one another relative to the axis in the lower throat portion of the fluid passage; and
wherein the third plurality of output apertures of the third air introduction system are provided as a pair of input ends and corresponding output apertures that are radially opposed to one another relative to the axis in the lower throat portion of the fluid passage.

19. The adjustable wine aerator of claim 18 further comprising:
a port selector that permits air to pass into an input end of a selected one of the first, second, and third air introduction systems and inhibits air from passing into an input end of unselected ones of the first, second, and third air introduction systems.

20. The adjustable wine aerator of claim 19 wherein the port selector comprises a cylindrical sleeve having a solid wall portion and an opposed pair of apertures, the cylindrical sleeve surrounding and rotating relative to the lower body portion, the opposed pair of apertures of the cylindrical sleeve aligning with the pair of input ends of a selected one of the first, second, and third air introduction systems, and the solid wall portion of the cylindrical sleeve simultaneously covering the input end of unselected ones of the first, second, and third air introduction systems.
